(19) United States
(12) Patent Application Publication
(10) Pub. No.: US 2007/0138135 A1
(43) Pub. Date: Jun. 21, 2007

(54) METHODS AND APPARATUSES FOR IMPRINTING SUBSTRATES

(76) Inventors: Todd L. Biggs, Queen Creek, AZ (US); Jeff R. Wienrich, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/554,549

(22) Filed: Oct. 30, 2006

Related U.S. Application Data
(62) Division of application No. 10/913,903, filed on Aug. 5, 2004.

(51) Int. Cl. C03C 25/68

(52) U.S. Cl. 216/58

(57) ABSTRACT

A method and apparatus for imprinting substrates. One embodiment of the invention provides a microtool having a sidewall on one or both plates. The sidewalls help prevent excess dielectric material from forming on the microtool plates or the substrate. For one embodiment of the invention, each microtool plate has a sidewall formed thereon. Upon application of pressure, the sidewalls contact each other, thus reducing or eliminating flexing of the microtool plates.

This application is a divisional application of U.S. application Ser. No. 10/913,903, filed on Aug. 5, 2004, currently pending.

### FIELD

Embodiments of the invention relate generally to the field of microelectronic device fabrication and more specifically to methods and apparatuses for imprinting substrates to fabricate such devices.

### BACKGROUND

One of the processes of fabricating a microelectronic device is imprinting a substrate. Typically, a substrate core, which may be a metal or an organic compound, has a layer of dielectric material disposed on one or both sides. The dielectric material may be comprised of a thermal setting epoxy. The dielectric layer may be applied as a flat sheet of thermal setting epoxy that is then imprinted to form traces. The traces are then plated with a conductive material (e.g., copper) to form electrically conductive traces for the microelectronic device circuits. Subsequent layers and associated electronic circuitry are formed to complete the device.

Typically, thermal setting epoxy layer is imprinted with an imprinting microtool. The conventional design of such microtools has many distinct disadvantages illustrated by FIGS. 1A-1C.

FIG. 1A illustrates a microtool in accordance with the prior art. The microtool plates 105 are typically a thin metal (e.g., a 30 mil nickel plate) with raised and recessed portions 106 and 107, respectively. The raised and recessed portions of the microtool are known as features and are typically about 50-70 microns from top to bottom. Each plate of the microtool is held in place by a vacuum (not shown) and pressed into the thermal setting epoxy layers 110 disposed on the substrate core 115. The epoxy layers are typically about 40 microns. Upon application of pressure, the recessed portions are filled with epoxy and the raised portions displace epoxy. One disadvantage of such a scheme is that the epoxy material is not contained; that is, there is nothing to prevent or restrict the flow of the epoxy in an undesired manner. When pressure is applied to the microtool plates, the epoxy material is allowed to flow out. A slight tilt in the apparatus could cause the epoxy to flow in undesired amounts and locations. The wetting properties of the epoxy material cause excess material to accumulate along the edge of the microtool plate, that is, the overflowing epoxy may build up around the edge of the plate causing a malformation of the desired features.

Also, because the microtool is comprised of thin plates, when under pressure the plates flex particularly along the outer edges where there is less epoxy material to provide resistance. This inward flexing along the edges causes nonuniformity in the thickness of the epoxy layer. This causes the epoxy layer to be thinner than desired near the edges.

FIG. 1B illustrates an epoxy layer formed using a microtool in accordance with the prior art. As shown in FIG. 1B, features 111 near the edge of epoxy layer 110 are malformed due to the flexing of the microtool plate. The flexing may be so pervasive as to create a “dimple” 112 in substrate core 115. Additionally, the raised portions 106 act as a standoff for the microtool and can therefore dimple substrate core 115.

This problem has been addressed with limited success by trying to gauge the amount of material so as to limit overflow. This has not proven very effective; when an insufficient amount of epoxy is used, the result is a defective part as described above. When an excessive amount of epoxy is used, the excess forms along the edge of the substrate, thus causing a subsequent planarization process to take longer. Additionally, the excess material is not uniform and therefore makes it difficult to hold a vacuum during subsequent processes. Moreover, the excess material causes the substrate to stick to the microtool plate. Removing the substrate (e.g., prying it from the plate) can damage the plate.

Over time, the repeated flexing of the microtool plates along the edges can cause the edges to become permanently deformed. Such deformation leads to defective substrate features and makes it difficult to maintain a vacuum on the plate.

FIG. 1C illustrates the deformation of a microtool plate in accordance with the prior art. As shown in FIG. 1C, plate 105 is deformed at edges 120. This deformation is due to repeated flexing of the plate, while imprinting an epoxy layer in which the epoxy has flowed in undesired amounts or locations.

### BRIEF DESCRIPTION OF THE DRAWINGS

The invention may be best understood by referring to the following description and accompanying drawings that are used to illustrate embodiments of the invention. In the drawings:

FIG. 1A illustrates a microtool in accordance with the prior art;

FIG. 1B illustrates an epoxy layer formed using a microtool in accordance with the prior art;

FIG. 1C illustrates the deformation of a microtool plate in accordance with the prior art;

FIG. 2 illustrates a microtool in accordance with one embodiment of the invention;

FIG. 2A illustrates a microtool in which one of two plates has a sidewall in accordance with one embodiment of the invention;

FIG. 3 illustrates a microtool having plates with sidewalls formed to contact the substrate core in accordance with one embodiment of the invention;

FIG. 4 illustrates a microtool having one or more vent holes formed therein to increase the flow of the dielectric material throughout the reservoir formed by the sidewalls in accordance with one embodiment of the invention;

FIG. 4A is a top-down view of a microtool plate having vent channels formed therein in accordance with one embodiment of the invention; and

FIG. 5 illustrates a process in which a microtool is formed in accordance with one embodiment of the invention.

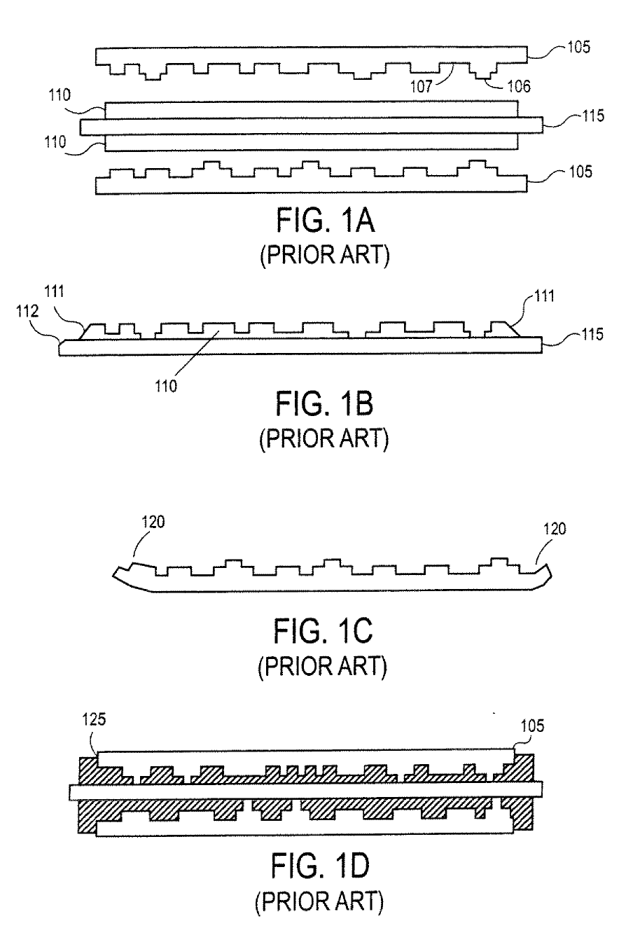

### DETAILED DESCRIPTION

In the following description, numerous specific details are set forth. However it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

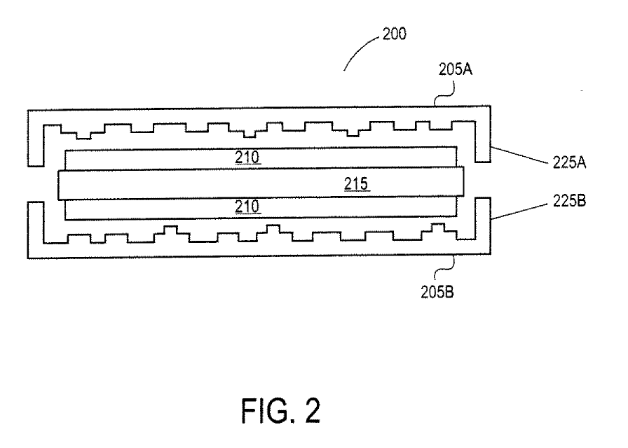

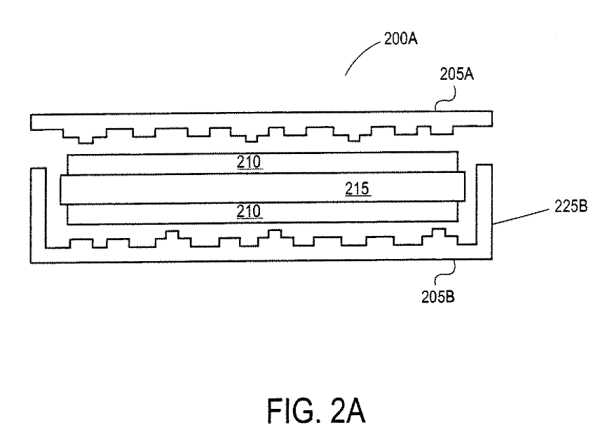

FIG. 2 illustrates a microtool in accordance with one embodiment of the invention. Microtool 200, shown in FIG. 2, includes sidewalls 225a and 225b on plates 205a and 205b, respectively. For one embodiment of the invention, the sidewalls are integrally formed with the plates and made of the same material as the plates, which may be nickel or a nickel alloy. The sidewalls form a reservoir around the imprint pattern (i.e., the features) of the microtool plates. The dimensions of sidewalls 225a and 225b are set to accommodate the thickness of substrate core 215 such that upon pressure being applied to the plates, the imprint pattern extends a desired amount into dielectric layers 210. The dielectric layers 210 may be comprised of thermal setting epoxy, thermoplastic or other suitable material. For one embodiment of the invention, each of the sidewalls 225a and 225b extend beyond the imprint pattern; a distance equal to approximately one half of the thickness of the substrate core 215.

Upon pressure being applied to the plates 205a and 205b, the sidewalls 225a and 225b contact each other. Because the sidewalls provide resistance one against the other, the amount of pressure applied is not as critical as in prior art schemes. For typically employed pressures, the edge of each plate will not flex due to the resistance created between sidewalls 225a and 225b. Additionally, in a closed or imprinting position, microtool 200 envelopes the entire substrate, thus the dielectric material cannot accumulate on the edge of the microtool plates nor can excess dielectric material form along the edge of the substrate. Moreover, tilting will not cause defective parts, as the dielectric material cannot flow as readily to undesired locations.

For one embodiment of the invention, the sidewalls of the microtool are positioned such that upon imprinting, the entire substrate is encapsulated within the dielectric material. Such an embodiment will result in reduction or elimination of the substrate sticking to the microtool.

Various alternative embodiments of the invention reduce or eliminate flexing of the microtool plates along the edges, flow of the dielectric material to undesired locations due to tilt, and accumulation of excess dielectric material along the edges of the substrate, thus providing an imprinted substrate having a total thickness variation (TTV) of approximately 7 microns.

In an alternative embodiment, only one of the microtool plates may include a sidewall FIG. 2A illustrates a microtool in which one of two plates has a sidewall in accordance with one embodiment of the invention. Microtool 200A shown in FIG. 2A, includes a sidewall 225 formed on the lower plate 205b. Plate 205a does not include a sidewall. For such an embodiment, the height of sidewall 225 is based upon the substrate core 215 such that upon pressure being applied to the plates, the imprint pattern extends a desired amount into the dielectric layers 210.

As described above in reference to FIG. 2, the microtool in accordance with one embodiment of the invention has sidewalls that contact each other during the imprinting process. For such an embodiment, the height of the sidewalls is determined within strict tolerances to ensure that the sidewalls do not prevent the imprint pattern from properly contacting the dielectric layer.

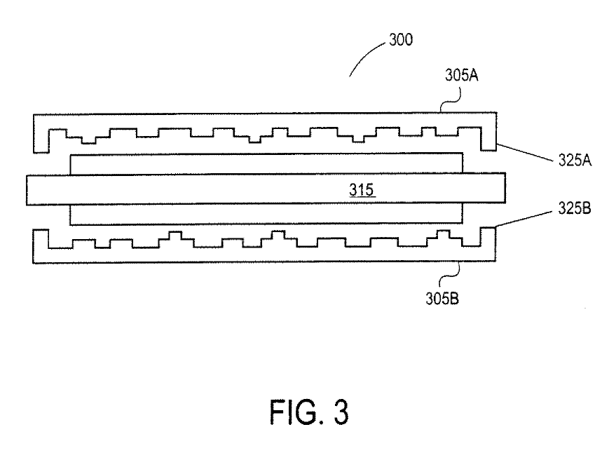

FIG. 3 illustrates a microtool having plates with sidewalls formed to contact the substrate core in accordance with one embodiment of the invention. Microtool 300, shown in FIG. 3, includes sidewalls 325a and 325b on plates 305a and 305b, respectively. As shown in FIG. 3, upon applying pressure to the plates, the sidewalls contact a substrate core 315. Each of the sidewalls 325a and 325b form a separate reservoir around the imprint pattern of each of the respective of the microtool plates, 305a and 305b.

For such an embodiment, it is no longer necessary to determine the height of the sidewalls based upon the thickness of the substrate core. Instead, the height of the sidewalls is approximately equal to the feature dimensions. Such an embodiment allows for ease of manufacturing. However, because the sidewalls will contact the substrate core, stricter tolerances on the applied pressure are observed to avoid dimpling the substrate core or damaging circuits with the substrate core.

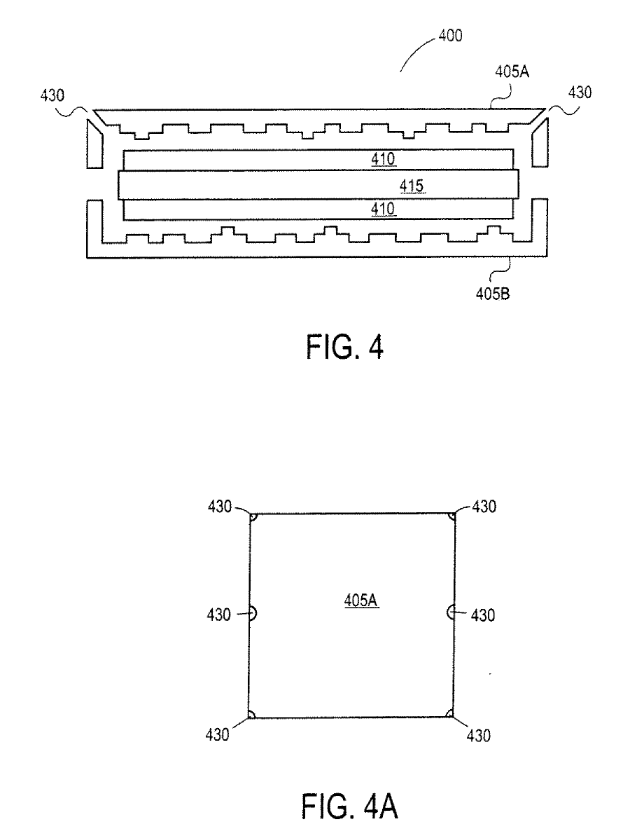

FIG. 4 illustrates a microtool having one or more vent channels formed therein to increase the flow of the dielectric material throughout the reservoir formed by the sidewalls in accordance with one embodiment of the invention. As shown in FIG. 4, microtool 400 has vent channels 430 formed in upper plate 405a. The vent channels may be formed at any location on the plate and may be formed additionally or alternatively on lower plate 405b. The dielectric material is less likely to flow into certain areas of the reservoir formed by the microtool plates. For example, the dielectric material is less likely to flow into the upper corners of the reservoir (i.e., the corners formed by the upper plate sidewalls). The vent channels help the dielectric material from the dielectric layer 410 to flow into such areas within the reservoir. Moreover, the vent channels allow excess dielectric material to escape from the reservoir without accumulating on the substrate or the microtool plates.

FIG. 4A is a top-down view of microtool plate 405a having vent channels 430 formed therein in accordance with one embodiment of the invention.

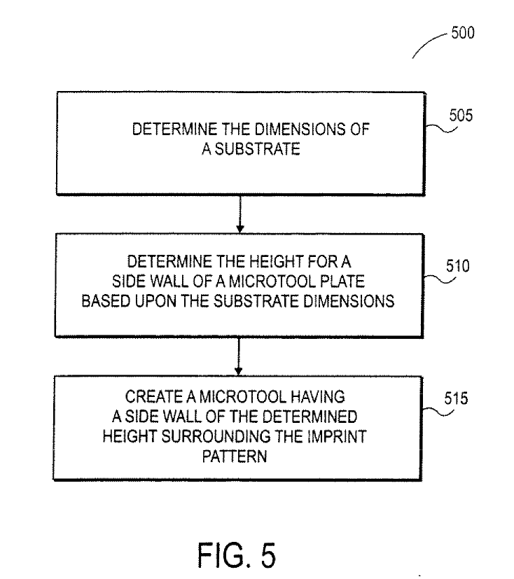

FIG. 5 illustrates a process in which a microtool is formed in accordance with one embodiment of the invention. Process 500, shown in FIG. 5, begins with operation 505 in which the dimensions of a substrate are determined. The dimensions may include the substrate core thickness as well as the dielectric layer thickness and the dimensions of the features to be imprinted on the substrate.

At operation 510, the height of a sidewall for a microtool plate is determined based upon the substrate dimensions. For example, for a microtool as described above in reference to FIG. 2, in which each sidewall will contact the sidewall of the opposing plate, the substrate core thickness as well as the feature dimensions are used to determine the sidewall height. For such an embodiment, the sidewall height for each plate is approximately equal to the feature height plus one half of the substrate core thickness. For a microtool as described in reference to FIG. 3, the sidewall height for each plate is approximately equal to the feature height.

At operation 515, a microtool is formed having a sidewall of the determined height on at least one plate surrounding the imprint pattern. Additionally, one or both plates of the microtool may have vent channels formed therein to aid the flow of the dielectric material as discussed above in reference to FIGS. 4 and 4A.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
determining one or more dimensions of a substrate;
determining a height of a sidewall for a microtool plate based upon a dimension of the substrate; and
forming a microtool having one or more plates, each plate having a corresponding imprint pattern formed thereon, at least one of the plates having a sidewall, each sidewall surrounding the corresponding imprint pattern of a respective plate.

2. The method of claim 1 further comprising:
forming vent channels within one or more of the plates of the microtool.

3. The method of claim 1 wherein each sidewall is integrally formed with the respective plate.

4. The method of claim 1 wherein each plate is a metal plate approximately 30 mils thick, the metal selected from the group consisting essentially of nickel and nickel alloy.

5. The method of claim 1 further comprising:
forming a sidewall on each of two opposing plates of the microtool wherein upon application of pressure each sidewall contacts the sidewall of the opposing plate such that the sidewall of each plate helps to prevent flexing of the opposing plate.

6. The method of claim 5 wherein the sidewalls in contact with each other form a reservoir for a dielectric material of the substrate such that an accumulation of an excess of the dielectric material on the substrate and each of the two plates is reduced.

7. The method of claim 1 further comprising:
forming a sidewall on each of one or more corresponding plates of the microtool wherein upon application of pressure each sidewall contacts a core of the substrate such that the sidewall in contact with the substrate core helps to prevent flexing of the corresponding plate.

8. The method of claim 1 further comprising:
imprinting the substrate using the microtool.
